(19) United States
(12) Patent Application Publication
(10) Pub. No.: US 2023/0356277 A1
(43) Pub. Date: Nov. 9, 2023

(54) METHOD FOR CLEANING RECLAIMED ASPHALT

(71) Applicant: Taylor J. Schmidt, San Marcos, CA (US)

(72) Inventor: Taylor J. Schmidt, San Marcos, CA (US)

(21) Appl. No.: 17/739,024

(22) Filed: May 6, 2022

(51) Int. Cl. B09C 1/02; B08B 3/12; B08B 3/04; B08B 3/10

(52) U.S. Cl. CPC B09C 1/02; B08B 3/044; B08B 3/102; B08B 3/12; B08B 2230/01

(57) ABSTRACT

A method is disclosed for removing oil from oil covered rocks of reclaimed asphalt that is milled from pavement of a roadway. The oil covered rocks are cleaned so as to be suitable to be mixed with virgin rocks to make new asphalt. The oil covered rocks are submerged within and moved through a water filled bath by an oil scrubber (e.g., a motor driven screw or set of paddles) where the rocks are agitated and rubbed together to cause the oil to separate therefrom. To enhance the oil removal process, steam is sprayed under pressure into the bath from an overhead manifold. To further enhance the oil removal process, the rocks are preheated within an insulated hot box prior to their receipt by the water bath. The cleaned rocks are removed from the bath to be collected, dried and recycled.

### BACKGROUND OF THE INVENTION

### 1. Field of the Invention

This invention relates to a method for removing oil from oil covered rocks of reclaimed asphalt that has been milled off pavement from a roadway that is old and/or in need of repair. By virtue of a method herein disclosed, the oil covered rocks from reclaimed asphalt pavement (RAP) can be advantageously cleaned and recycled so as to be mixed with virgin rocks for making new asphalt.

### 2. Background Art

Asphalt which is commonly used to construct pavement for a roadway is a petroleum based material. Accordingly, the rocks from which asphalt is produced are typically coated with oil. In cases where an asphalt pavement is either old and/or damaged, it is often necessary to mill a layer of the original asphalt off the roadway so that repairs can be made. As a consequence of the asphalt layers that have been removed over time, tons of reclaimed asphalt pavement (RAP) are stockpiled in landfills and other storage sites. Because the grinds (i.e., rocks) which have been milled off the original asphalt surface are covered with oil, the RAP is either discarded or piled up and wasted. In either case, the RAP goes unused and, therefore, must be replaced with entirely new asphalt which increases the costs for constructing an asphalt pavement.

What would therefore be desirable is a simple method by which the grinds from the reclaimed asphalt pavement can be cleaned and the oil with which the grinds are covered can be removed so that the grinds can be recycled and mixed with virgin rocks for making new asphalt.

### SUMMARY OF THE INVENTION

Briefly, and in general terms, a method is disclosed for cleaning and removing oil from the oil covered rocks of reclaimed asphalt that has been milled (i.e., scraped off) from an asphalt covered pavement. The oil covered rocks of the reclaimed asphalt pavement (RAP) are initially loaded into a hopper to be placed on a conveyor belt. The conveyor belt carries the rocks to a bath that is filled with water within which the rocks are submerged. In one embodiment, an insulated hot box that contains a source of heat is positioned between the conveyor belt and the water bath. The hot box preheats the oil covered rocks prior to their receipt by the water bath. An oil scrubber runs through the water bath. By way of a preferred embodiment, the oil scrubber includes at least one motor driven shaft that is turned to rotate a screw or a set of blades (i.e., paddles) extending therefrom. An overhead manifold to which steam is pumped from a steam unit sprays the steam into the water bath.

The shaft of the oil scrubber is turned to cause the submerged oil covered rocks to move through the water bath. The rocks from which the RAP is formed are agitated by the scrubber and caused to rub against one another. The combination of the steam provided by the overhead manifold and the agitation provided by the scrubber causes the oil to separate from the rocks. An oily mixture is then removed from the bath to an oil/water separator at which the oil and the water are separated from one another to be reused. The rocks from which the oil has been separated are now cleaned and ready to be removed from the water bath to a collection bin. The clean rocks within the collection bin are available to be advantageously dried and recycled as fresh aggregate to be mixed with virgin rocks for making new asphalt.

### BRIEF DESCRIPTION OF THE DRAWINGS

FIG. 1 illustrates apparatus having an oil scrubber for performing a method for cleaning oil covered rocks from reclaimed asphalt pavement according to the present invention;

FIG. 2 is a side view of a first alternate oil scrubber to be used by the apparatus shown in FIG. 1;

FIG. 3 is a top view of the first alternate oil scrubber when viewed in the direction of lines 3-3 of FIG. 2;

FIG. 4 is a top view of a second alternate oil scrubber to be used by the apparatus shown in FIG. 1;

FIG. 5 shows the second alternate oil scrubber when viewed in the direction of lines 5-5 of FIG. 4;

FIG. 6 shows the modification of a hot box added to the apparatus of FIG. 1 for cleaning oil covered rocks; and

FIG. 7 shows details of the hot box of the modified apparatus of FIG. 6.

### DESCRIPTION OF THE PREFERRED EMBODIMENT

A method for reconditioning reclaimed asphalt is now described while referring to the drawings. By virtue of the method herein disclosed, previously used asphalt rock that has been coated with oil can be cleaned and recycled for use with fresh rock to make new asphalt for constructing new asphalt pavement. Moreover, the massive amounts of reclaimed asphalt pavement that would otherwise sit idle and remain unused at a storage site can now be reconditioned and repurposed for use in new paving jobs.

In order to economically make and lay an asphalt pavement, approximately two inches of an old or damaged asphalt pavement are first removed (i.e., milled) from the pavement to be treated and cleaned. The layer of asphalt that is removed commonly includes course reclaimed asphalt pavement (RAP) and fine reclaimed asphalt pavement. The course RAP is separated from the fine RAP by a conventional fractionation process. The rocks of the fine RAP which have a high sand content do not need to be treated and cleaned but can be reused in their present form and independently of the method herein disclosed. However, rocks of the course RAP which retain a high oil content are treated according to the method described below by which the oil is stripped away from the rocks to produce clean rocks to be reused to make new asphalt

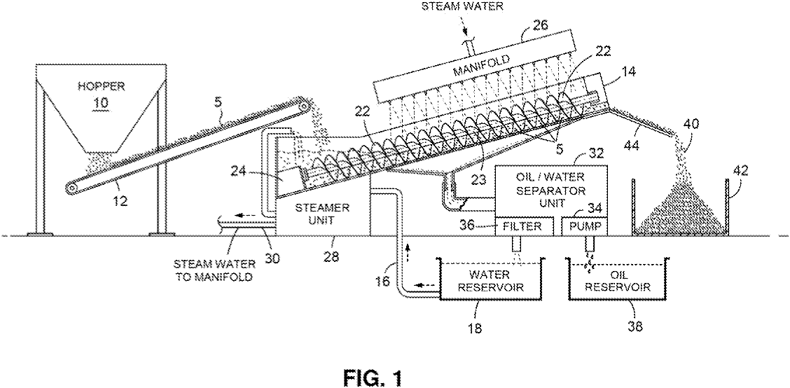

Referring initially to FIG. 1 of the drawings, my asphalt cleaning method begins when the oil covered rocks 5 of the course RAP are dropped by a front loader or similar vehicle into a hopper 10. A conveyor belt 12 carries the oil covered rocks 5 from the hopper 10 upwardly to a bath 14. The bath 14 is filled with fresh water that is pumped through a water conduit 16 from a water reservoir 18, so that the rocks 5 are submerged in the water. At the same time, an optional organic cleaner may be added to the water bath 14.

The water bath 14 inclines upwardly, and an oil scrubber 22 runs through the water, The oil scrubber 22 is preferably a screw (sometimes known as a pug mill) that is turned on a shaft 23 which is rotated by a screw motor 24 to move the submerged rocks 5 through the bath 14. The rotating screw of the scrubber 22 agitates the mixture of oil covered rocks 5 and water as the rocks travel upwardly through the water bath 14.

A steam manifold 26 is located above the water bath 14. The manifold 26 communicates with a steam generating unit 28 by way of a steam conduit 30. The steamer unit 28 is preferably one that is powered by natural gas. The steamer unit 28 converts water having a temperature above 300° F. into steam to be pumped under pressure via conduit 30 to the manifold 26. The overhead manifold 26 sprays the steam being supplied thereto into the water bath 14 and against the mixture of the water and the oil covered rocks 5 that are agitated by the scrubber 22. The rotating screw of the oil scrubber 22 causes the rocks 5 to rub against one another. This agitation and the addition of the steam being sprayed under pressure into the water bath 14 by the overhead steam manifold 26 causes the oil to separate from the rocks.

The water bath 14 communicates with an oil/water separator 32. Accordingly, the mixture of oil and water is removed from the water bath 14 to the separator 32. The oil/water separator 32 includes a pump 34 by which to draw the oily water out of the water bath 14. By way of example only, a suitable separator and pump unit to be used for this purpose is an OS series separator available from SkimOil of Hudson, Ohio.

The oil/water separator 32 also includes a filter 36. The filter 36 communicates with the aforementioned water reservoir 18 that supplies the water to fill the bath 14. By virtue of the filter 36, the water reservoir 18 can be continuously resupplied with fresh water that is recycled from the water bath 14. The oil that has been removed from the oil covered rocks of the course RAP is supplied by the oil/water separator 32 to an oil reservoir 38 at which it is collected for reuse.

The clean rocks 40 from which the oil has been removed are dropped from the top of the oil scrubber 22 into a collection bin 42 via a ramp 44. In the alternative, the clean rocks 40 can be moved from the first scrubber 22, as shown, to a second scrubber, not shown. In that case, the oil covered rocks 5 are treated by a pair of end-to-end scrubbers. In the first case, where a single scrubber 22 is used to remove the oil from the rocks 5, the clean rocks 40 that fill the collection bin 42 are available to be dried and recycled as fresh asphalt aggregate to be mixed with virgin rocks for making new asphalt for a new asphalt surface.

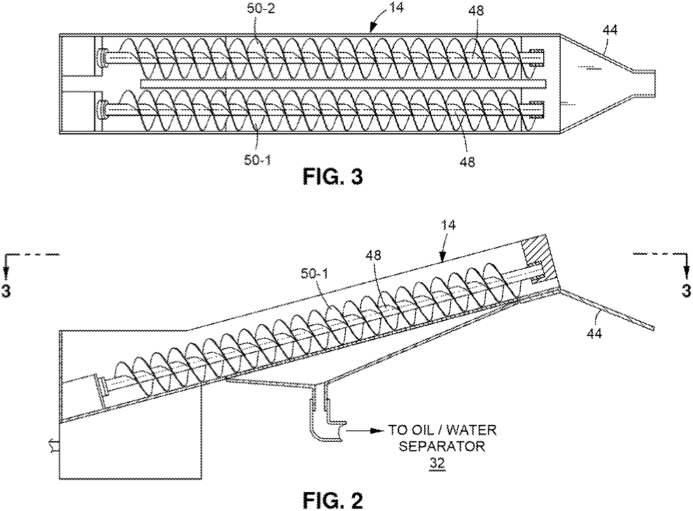

By way of a first modification, the single oil scrubber 22 shown in FIG. 1 can be replaced by a pair of motor driven oil scrubbers 50-1 and 50-2 as shown in FIGS. 2 and 3. The pair of oil scrubbers 50-1 and 50-2 have identical rotating screws that are turned on shafts 48 which are aligned side-by-side one another and housed within the bath 14.

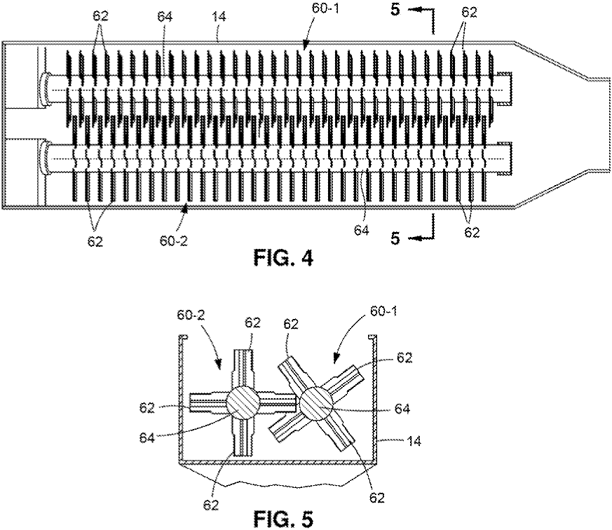

By way of a second modification, the rotating screws of the oil scrubbers 20, 50-1 and 50-2 that run through the water bath 14 shown in FIGS. 1-3 can be replaced by one or more (e.g., a pair) of oil scrubbers 60-1 and 60-2 as shown in FIGS. 4 and 5 of the drawings. In this case, each of the pair of oil scrubbers 60-1 and 60-2 has a plurality of blades that are commonly referred to as paddles 62 uniformly spaced from one another and extending outwardly from a motor driven shaft 64. As in the case of the oil scrubbers 50-1 and 50-1 of FIG. 3, the oil scrubbers 60-1 and 60-2 of FIG. 4 are aligned side-by-side one another through the water bath. When the shafts 64 rotate, the paddles 62 carried by the shafts are correspondingly rotated to move the submerged rocks to be cleaned through the bath 14 while simultaneously causing the rocks to be agitated and rub together.

In this same regard, it is to be understood that the oil scrubbers used to move and agitate the oil covered rocks may be any other suitable device that is capable of causing the oil covered rocks (designated 5 in FIG. 1) to continuously tumble over one another for aggregate-on-aggregate abrasion while at the same time causing the rocks to move through the water bath.

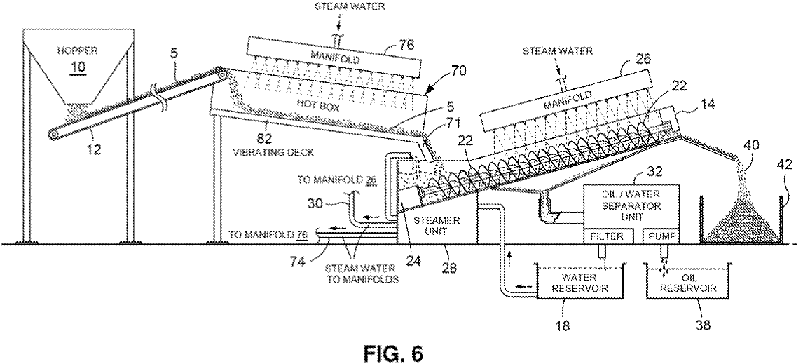

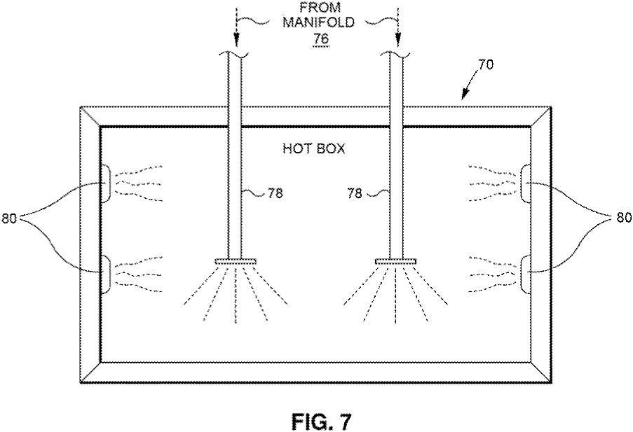

Turning now to FIGS. 6 and 7 of the drawings, a variation is described to the apparatus shown in FIG. 1 for cleaning oil covered rocks from reclaimed asphalt pavement. Identical reference numerals are used in FIG. 6 to correspond to identical apparatus shown in FIG. 1. In particular, a hot box 70 is added to the apparatus of FIG. 1 to lie in front of the water bath 14 so as to preheat the rocks 5 ahead of the bath 14 to better enable the oil to be separated therefrom.

The hotbox 70 in a fully enclosed insulated container into which the rocks 5 are loaded by the conveyor belt 12. The preheated rocks 5 that exit the hot box 70 are loaded via a chute 71 into the water bath 14 to be agitated therein as previously described. The hot box 70 is insulated by a (e.g., two inch) air gap 72 as shown in FIG. 7 to reduce the loss of heat to the atmosphere. To generate the heat within the hot box 70 to heat the rocks 5, steam from the steamer unit 28 that is supplied by the steam conduit 30 to the manifold 26 overhead the water bath 14 is also supplied by a steam conduit 74 to a second overhead manifold 76 that lies above the hot box 70. The steam is delivered from conduit 74 by way of steam nozzles 78 that project downwardly from the manifold 76 through the hot box 70 (best shown in FIG. 7). Additional heat may be supplied to the hot box depending upon the composition of the rocks to be cleaned by a heat source such as, for example, an array of optional infrared heating lamps 80 (also best shown in FIG. 7).

The hot box 70 is seated on a vibrating deck 82. The vibrations applied to the hot box 70 by the vibrating deck 82 move the rocks 5 to be cleaned through the hot box and down the exit chute 71 to the water bath 14. To this end, the hot box 70 is preferably angled downwardly between the conveyor belt 12 and the water bath 14. The angle of the hot box 70 can be adjusted according to the desired throughput to be handled by the apparatus.

It may be appreciated that the method disclosed herein does not add to the existing stockpiles of reclaimed asphalt pavement that have heretofor gone largely unused. Moreover, by being able to clean and recycle previously used asphalt, the cost for making new asphalt pavement can be more economically accomplished.

1. A method for removing oil from oil covered rocks of reclaimed asphalt, said method comprising the steps of:
loading the oil covered rocks of the reclaimed asphalt into a bath containing water;
5 agitating the oil covered rocks within the water of the bath to cause the rocks to rub against one another and the oil with which the rocks are covered to separate from the rocks so that the rocks are cleaned of oil; and
removing the cleaned rocks from the water of the bath.

2. The method recited in claim 1, comprising the additional step of mixing the cleaned rocks removed from the water of the bath with other rocks for making new asphalt.

3. The method recited in claim 1, comprising the additional step of spraying steam under pressure into the water of the bath at the same time that the oil covered rocks are agitated within the water of the bath.

4. The method recited in claim 3, comprising the additional step of spraying the steam under pressure into the water of the bath from a manifold that is located above the bath.

5. The method recited in claim 4, comprising the additional step of supplying the steam under pressure from a steam generating unit to the manifold to be sprayed from said manifold into the water of the bath.

6. The method recited in claim 1, wherein the step of agitating the oil covered rocks within the water of the bath is performed by at least one screw turning within the water for moving the oil covered rocks through the bath.

7. The method recited in claim 1, wherein the step of agitating the oil covered rocks within the water of the bath is performed by at least one shaft having a plurality of blades projecting therefrom and rotating within the water for moving the oil covered rocks through the bath.

8. The method recited in claim 1, wherein the water within the bath is mixed with the oil that is separated from the oil covered rocks during the step of agitating the oil covered rocks, said method comprising the additional steps of removing the mixture of water and oil from the bath and separating the oil from the water.

9. The method recited in claim 8, comprising the additional steps of filling the bath within which the oil covered rocks are loaded with water from a water reservoir; and returning the water that is removed with the mixture of oil and water and separated from the oil to the water reservoir.

10. The method recited in claim 8, comprising the additional step of storing in an oil reservoir the oil that is removed with the mixture of oil and water and separated from the water.

11. The method recited in claim 1, comprising the additional step of loading the oil covered rocks into the bath containing water by way of a conveyor belt on which the rocks are carried.

12. The method recited in claim 1, comprising the additional step of heating the oil covered rocks prior to the oil covered rocks being loaded into the water of the bath.

13. The method recited in claim 12, comprising the additional step of heating the oil covered rocks within an insulated hot box.

14. The method recited in claim 13, comprising the additional step of heating the oil covered rocks within the insulated hot box by means of a source of heat located within said insulated hot box.

15. The method recited in claim 13, comprising the additional step of heating the oil covered rocks within the insulated hot box by means of spraying steam into the insulated hot box.

16. The method recited in claim 12, comprising the additional step of seating the insulated hot box on a vibrating deck that vibrates for causing said hot box to vibrate and the oil covered rocks to move through said hot box and into the water of said bath.
